(19) United States
(12) Patent Application Publication
(10) Pub. No.: US 2002/0194979 A1
(43) Pub. Date: Dec. 26, 2002

(54) Support bracket for a percussion instrument pedal assembly

(76) Inventor: Wu-Hong Hsieh, Lu Chou City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 09/888,874

(22) Filed: Jun. 25, 2001

(51) Int. Cl. G10D 13/02

(52) U.S. Cl. 84/421

(57) ABSTRACT

A support bracket for a percussion instrument pedal assembly comprises a base, two posts extending up from the base and a clamp integrally formed on the top end of each post. Each clamp has a chamber defined in each end of the clamp to securely receive a bearing. By such an arrangement, the mounting of the bearings will be simplified. The supporting effect of each rotating rod can be improved. In addition the position of the support brackets for the pedal assembly are adjustable, and the versatility of the support bracket can be improved.

### BACKGROUND OF THE INVENTION

1. Field of the Invention

The present invention relates to a support bracket, and more particularly to a support bracket for a percussion instrument pedal assembly.

2. Description of Related Art

With reference to FIGS. 6 and 7, a conventional percussion instrument pedal assembly in accordance with the prior art drives a mallet to make sound by striking a percussion instrument like a drum. The conventional pedal assembly comprises two pairs of support brackets (50), a rotating rod (64), an actuating rod (66), a segmented rotating rod (60), two mallet holders (74,76), a rotating linkage and two pedals (78,782) to control the rotation of the mallet holders (74,76). Each mallet holder (74,76) is fixedly mounted on separate sections of the segmented rotating rod (60) to hold a mallet. Each rotating rod (60, 64) is rotatably mounted between a pair of support brackets (50). A cam (70) is mounted on each rotating rod (60, 64). The cam (70) on the segmented rotating rod (60) is mounted on the outer segment. A chain (702) is secured around each cam (70) and connected to the corresponding pedal (78,782). An actuating rod (66) is mounted between the rotating rods (64) mounted in the supporting brackets (50). By such an arrangement, the mallet holders (74,76) can be made to rotate independently of each other. When the user steps on the left pedal (782), the inside mallet holder (76) will rotate. When the user steps on the right pedal (78), the outside mallet holder (74) will rotate.

A bearing (80,82,84,86) is mounted on each end of each rotating rods (60, 64) and rotating rod (60) segment. Consequently, four bearings (80,82,84,86) are mounted on the bracket (50) to accommodate the two rotating rods (60,62). To effectively mount the segmented rotating rod (60), a bearing holder (52) is mounted on the bracket (50) to hold two bearings (82,84). However, it is very difficult to put the two bearings (82,84) into the holder (52) and to extend the two rotating rod (61, 62) through the corresponding bearings (82,84) in the holder (52). The mounting of the bearings (80,82,84,86) in the conventional brackets (50) is very difficult. In addition, a jolt easily occurs when the pedal assembly is operating due to a slight difference in dimension between the holder (52) and bearings (82,84).

With reference to FIG. 8, another type of conventional supporting bracket (50) has a supporting wheel (54) secured to the end of the second rotating rod segment (61). A bearing (82) is received in the other side of the supporting wheel (54) to hold one end of the first rotating rod segment (62). A chain (702) is connected to a cam (70) that is mounted on the periphery of the wheel (54). Consequently, the two rotating rod segments (61, 62) can be rotatably mounted on the supporting bracket (50) through the supporting wheel (54) with one less bearing. However, because the rotating rod (60) secured to the wheel (54) is only supported on one side, the rotating rod (60) is not stable enough. Furthermore, because the wheel (54) is securely attached to the cam (70), the wheel (54) easily jolts when the user steps on the pedal (78) and the cam (70) is pulled by the chain (702). The useful life of the bearings (80,82,84) will be shortened because of the jolt. In addition, the positions between the conventional supporting brackets (50) as described are not adjustable, i.e. the right bracket (50) can not be moved toward or away from to accommodate the user's natural foot position. The versatility of using the conventional supporting bracket (50) is limited.

To overcome the shortcomings, the present invention tends to provide an improved supporting bracket to mitigate or obviate the aforementioned problems.

### SUMMARY OF THE INVENTION

The main objective of the invention is to provide an improved support bracket for a percussion instrument pedal assembly. The supporting bracket comprises a base, two posts extending upward from the base and a clamp integrally formed on the top end of each post. Each clamp has a chamber defined in each end of the clamp to securely receive a bearing. With such a support bracket, the assembly and replacement of the bearings will be simplified. The supporting effect of each rotating rod can be improved.

The other objective of this invention is to provide an improved supporting bracket comprising two clamps each having two chambers, so that the bracket can mount two or four bearings to fit with one or two rotating rods respectively. Consequently, the position of the supporting bracket for the pedal assembly is adjustable, and the versatility of the supporting bracket can be improved.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view in partial section of a supporting bracket in accordance with the present invention;

FIG. 2 is an operational front plan view in partial section of the supporting bracket in FIG. 1;

FIG. 3 is another operational front plan view in partial section of the supporting bracket in FIG. 1;

FIG. 4 is a front plan view in partial section of a percussion instrument pedal assembly using the supporting brackets in FIG. 1;

FIG. 5 is a front plan view in partial section of another embodiment of a percussion instrument pedal assembly using the supporting brackets in FIG. 1;

FIG. 6 is a perspective view of a conventional percussion instrument pedal assembly in accordance with the prior art;

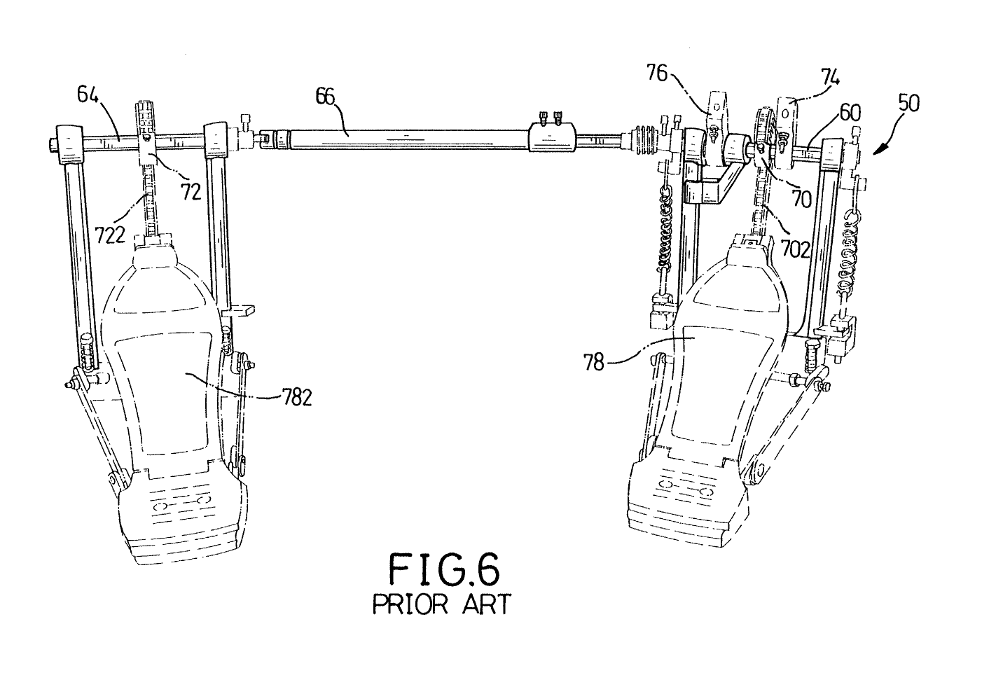

FIG. 7 is a front plan view in partial section of a conventional supporting bracket of the percussion instrument pedal assembly in FIG. 6; and

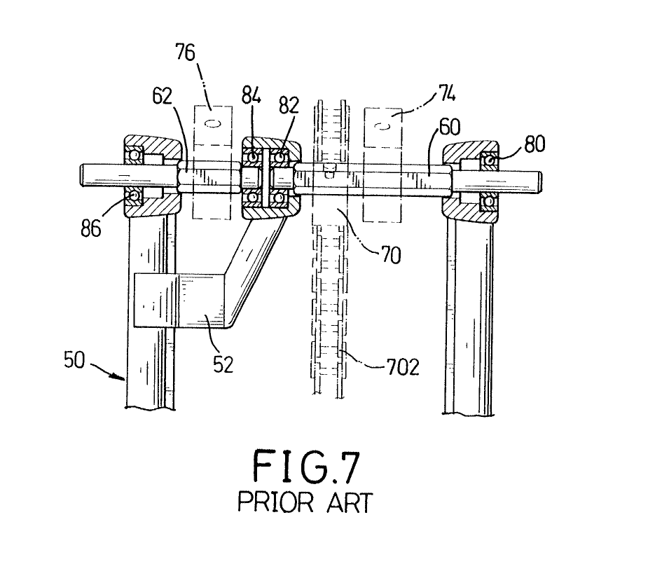

FIG. 8 is a front plan view in partial section of another embodiment of the conventional supporting bracket for the percussion instrument pedal assembly in accordance with the prior art.

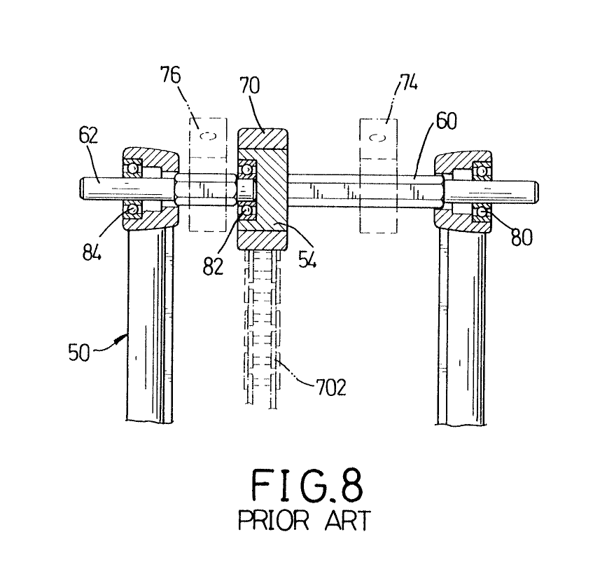

### DETAILED DESCRIPTION OF PREFERRED EMBODIMENT

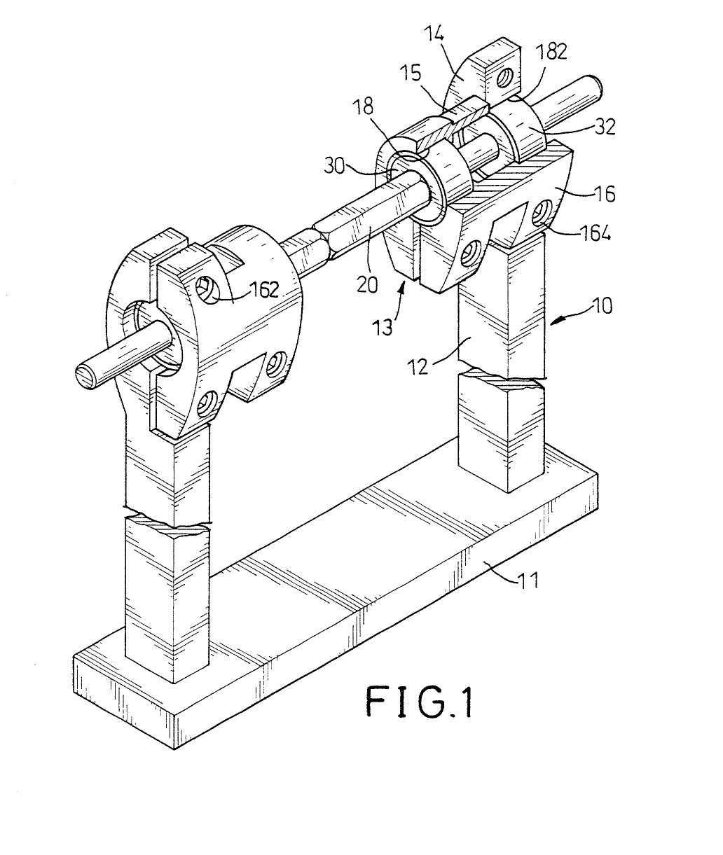

With reference to FIG. 1, a support bracket (10) for a percussion instrument pedal assembly in accordance with the present invention comprises a base (11), two posts (12) and two clamps (13). Each post (12) extends upward from the base (11), and the posts (12) are parallel with each other. Each clamp (13) includes a rear body (14) integrally formed on the top end of the corresponding post (12) and a front body (16) extending down from the top flange of the rear body (14) with a connecting portion (15). Each clamp (13) has two bearing chambers (18,182). The first bearing chamber (182) is defined in the facing surfaces of the rear body (14) and front body (16) on one end of the clamp (13), such that a bearing (32) can be received and held in the chamber (182) when the front body (16) is attached to the rear body (14). Another bearing (30) can be pressed into and held in the chamber (18) formed in the other end of the rear body (14).

At least one through hole (162) is defined in the front body (16). A threaded hole (not shown) is defined in the rear body (14) corresponding to each through hole (162) in the front body (16). A bolt in each through hole (162) screws into the corresponding threaded hole to attach front body (16) to the rear body (14). Consequently, the bearings (32) can be securely held in the chamber (182). Another through hole (164) and corresponding threaded hole (not shown) are formed in the other end of the front body (16) to hold the bearing (30) in place after it is inserted into the chamber (18).

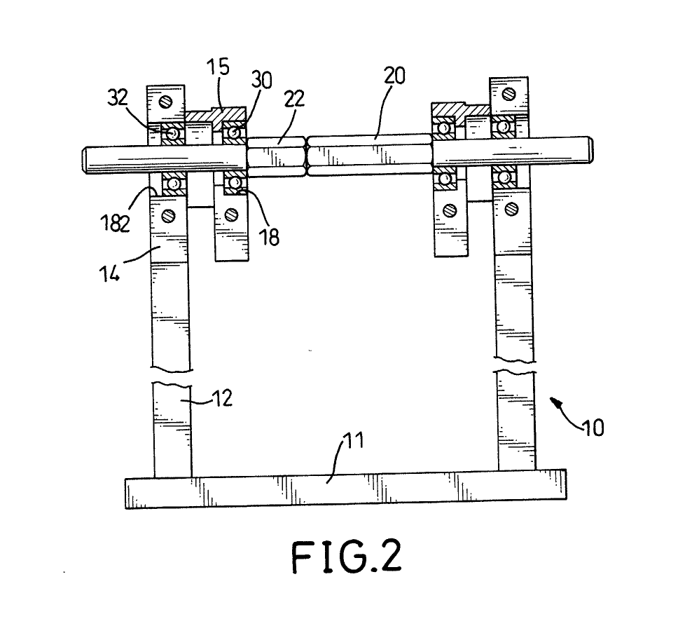

With reference to FIG. 2, a bearing (30,32) can be mounted in each chamber (18,182) of each clamp (13), such that a rotating rod segment (20, 22) can respectively fit with each pair of bearings (30,32) in one of the clamps (13).

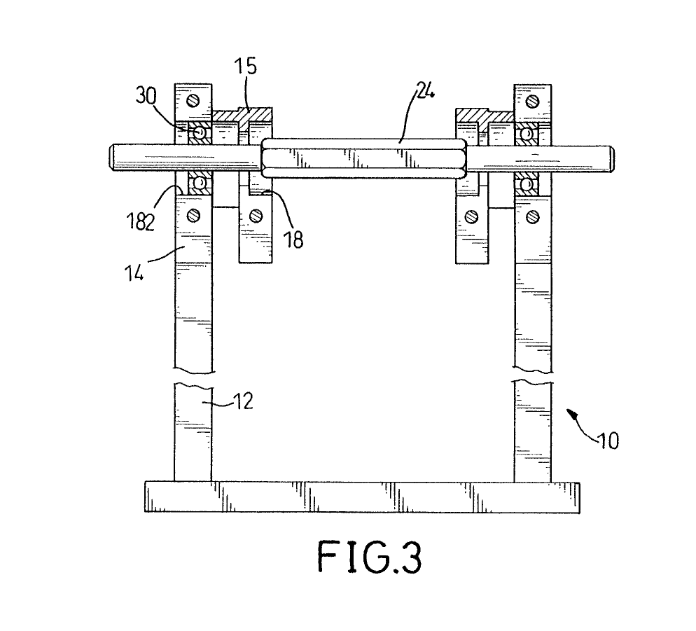

With reference to FIG. 3, in another configuration, one bearing (30) can be mounted in one of the chambers (18,182) in each clamp (13) to mount a one-piece rotating rod (24) in the supporting bracket (10). Because the pressure to hold the bearings (30, 32) in the chambers (18, 182) in the bracket (10) is generated by tightening the bolts, the bearings (30,32) are easily mounted in the bracket (10) by loosening and lightening the bolts.

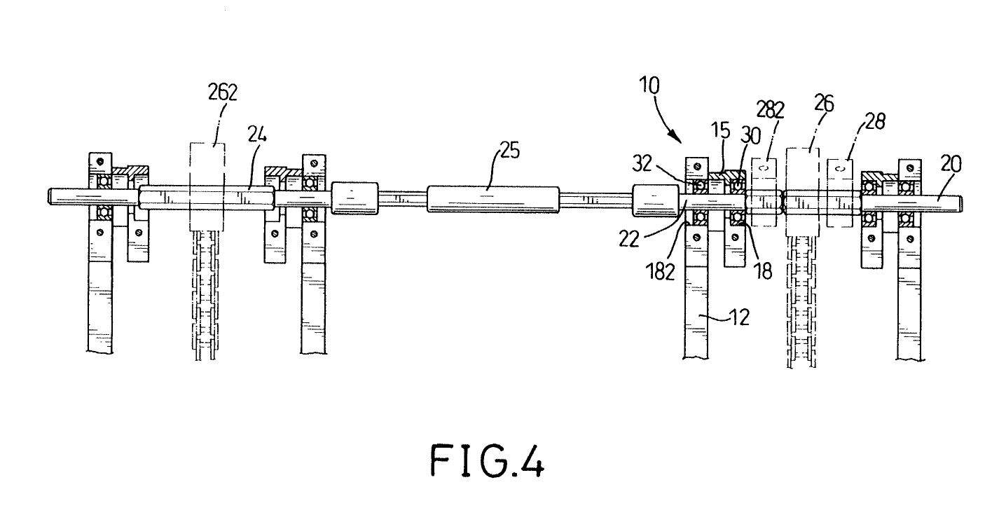

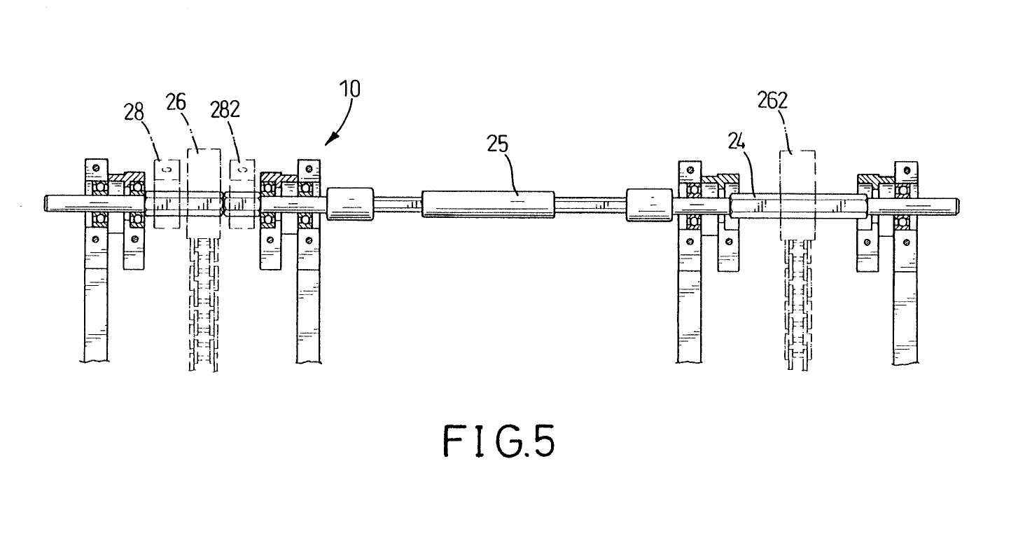

With reference to FIGS. 4 and 5, one support bracket (10) is arranged with two rotating rod segments (20, 22) with a mallet holder (28, 282) mounted on each rotating rod segment (20, 22). A cam (26) is mounted on the outer rotating rod segment (20). Another supporting bracket (10) is configured with a one-piece rotating rod (24) on which a cam (262) is mounted. A chain is attached around each cam (26, 262) and connects to a corresponding pedal (not shown). An actuating rod (25) is connected between the rotating rods (22, 24), such that a percussion instrument pedal assembly can be provided.

By such an arrangement, two support brackets (10) can be arranged with one or two rotating rods (20, 22, 24) so as to form a desired percussion instrument pedal assembly. The position of the brackets (10) on which one or two rotating rods (20, 22, 24) are mounted can be exchanged to fit with the user. Consequently, the versatility of the supporting bracket (10) can be improved.

In addition, because each rotating rod (20, 22, 24) is supported by two bearings (30, 32), so the stability of each rod (20,22,24) can be improved. This can do away with the jolting of the rotating rod (20, 22, 24) when the pedal assembly is in use. The useful life of the bearings (20, 22, 24) can be prolonged.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A supporting bracket for a percussion instrument pedal assembly, the supporting bracket comprises:
a base;
two posts extending upward from the base; and
a clamp integrally formed on a top end of each post and having a chamber defined in each end of the clamp to selectively receive a bearing.

2. The supporting bracket as claimed in claim 1, wherein the clamp includes a rear body integrally formed on the top end of the post; and
a front body extending downward from a top flange of the rear body,
wherein each chamber is defined between the rear body and front body.

3. The supporting bracket as claimed in claim 2, wherein at least one through hole is defined in the front body;
a threaded hole is defined in the rear body to correspond and align with each through hole of the front body;
a bolt extends each through hole and screws into the corresponding threaded hole.
